(19) United States
(12) Patent Application Publication
(10) Pub. No.: US 2012/0109939 A1
(43) Pub. Date: May 3, 2012

(54) METHOD AND APPARATUS FOR ENRICHING SEARCH RESULTS

(75) Inventor: Pavel KRAVETS, Ashdod (IL)

(73) Assignee: SAP Portals Israel Ltd, Ra'anana (IL)

(21) Appl. No.: 12/916,546

(22) Filed: Oct. 31, 2010

(51) Int. Cl. G06F 17/30

(52) U.S. Cl. 707/722; 707/E17.014

(57) ABSTRACT

A method and apparatus for providing search data by a processor at a computer, comprising: receiving a query issued by the user and passing the query to one or more computing entities; receiving at a first result and a second result from one of the computing entities; identifying one or more common characteristics of the first result and the second result; and returning a result set comprising the first result and the second result, the result set being searchable in accordance with any of the common characteristics.

### TECHNICAL FIELD

The present disclosure relates to computerized searches in general, and to a method and apparatus for providing a user with enriched search results, in particular.

### BACKGROUND

Computer users nowadays search and consume information from various sources on a daily basis, and sometime as often as multiple times a day.

Some of the sources are on-demand sources, which are generally available to the public, for example over the internet. Generally, on-demand sources are not under the user's control but a user can generally access them whenever he or she desires to. A popular type of on-demand sources relates to social networks. A social network comprises structured data that relates to individuals or organizations, referred to as nodes, which are interconnected by one or more types of interdependency, such as friendship, kinship, common interest, financial exchange, likes, dislikes, beliefs, knowledge, prestige, or any other. A social network enables a user to explore a part of a network for which he or she has access according to the network policy. For example a person that participates in such network can view data related to another participant, wherein the data may depend on the relationships between the person and the other participant. Thus, a person may be able to access some or all of the available data related to other participant which indicated the person as an associate of some level, and only basic information such as name, related to other participants. Some social networks apply persistency rules, for example by forbidding a user to store on a persistent storage device information related to other users.

Other data sources, common especially in organizational environments, comprise on-premise sources, such as organizational databases, organizational charts, or the like which are owned, managed and optionally stored by the organization or by an entity in the organization's behalf. Such sources and their a structure and contents are under the control of the organization, and may be of proprietary format.

Current search tools, such as search engines provide search results based on one or more queries issued by the user. A query may be introduced by typing texts, or by using a dedicated user interface, for example by navigating through menu options.

The query can be passed to one or more computing entities, whether on-premise, on-demand, or both, and search results are received which match or otherwise provide information related to some degree to the query.

There is however a need in the art for a method and apparatus that will provide enriched search results, without further effort on the user's side.

### SUMMARY

A method and apparatus for providing search results.

One aspect of the disclosure relates to a method for providing search results by a processor at a computer, comprising: receiving a query issued by the user and passing the query to one or more computing entities; receiving at a first result and a second result from one or more of the computing entities; identifying one or more common characteristics of the first result and the second result; and returning a result set comprising the first result and the second result, the result set being searchable in accordance with one or more of the common characteristics. The method can further comprise prioritizing or adjusting the common characteristics. The method can further comprise storing the common characteristics on a persistent storage device. Within the method, any of the common characteristics can be a corresponding attribute of the first result and the second result or a corresponding value of the first result and the second result. Within the method, identifying any of the common characteristics is optionally done using one or more methods selected from the group consisting of: regular expressions; string matching; pattern matching; value containment; and a textual similarity measurement. Within the method, the computing entity is optionally a computer, a service, a program, an application, a portal, a demon, a search engine, or a web service.

Another aspect of the disclosure relates to an apparatus for providing search results, comprising: a query receiving and passing component for receiving a query issued by a user, and passing the query to a computing entity; a result receiving component for receiving a first result and a second result from the computing entity; a common characteristic identification component for identifying one or more common characteristics of the first result and the second result; and a result returning component for returning a result set comprising the first result and the second result, the result set being searchable in accordance with one or more of the common characteristics. The apparatus can further comprise a prioritizing or adjusting component for prioritizing or adjusting the common characteristics. The apparatus can further comprise a storage device for storing one or more of the common characteristics in a persistent manner. Within the apparatus, each of the common characteristics is optionally a corresponding attribute of the first result and the second result or a corresponding value of the first result and the second result. Within the apparatus, identifying any of the common characteristics is optionally done using a method selected from the group consisting of: regular expressions; string matching; pattern matching; value containment; and a textual similarity measurement. Within the apparatus, the computing entity is optionally a computer, a service, a program, an application, a portal, a demon, a search engine, or a web service. The apparatus can further comprise a user interface component for letting a user search within the result set in accordance with any of the common characteristics.

Yet another aspect of the disclosure relates to a computer readable storage medium containing a set of instructions for a general purpose computer, the set of instructions comprising: receiving a query issued by a user and passing the query to one or more computing entities; receiving a first result and a second result from the any of the computing entities; identifying one or more common characteristics of the first result and the second result; and returning a result set comprising the first result and the second result, the result set being searchable in accordance with any of the common characteristics. Within the computer readable storage medium, the set of instructions can further comprise prioritizing or adjusting the common characteristics. Within the computer readable storage medium, the set of instructions can further comprise storing any of the common characteristics on a persistent storage device. Within the computer readable storage medium, any of the common characteristics is optionally a corresponding attribute of the first result and the second result, or a corresponding value of the first result and the second result. Within the computer readable storage medium, identifying any of the common characteristic can be done using a method selected from the group consisting of: regular expressions; string matching; pattern matching; value containment; and a textual similarity measurement.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic block diagram of an environment in which the disclosed method and apparatus is used;

FIG. 2 is a schematic illustration of an apparatus for providing enriched search, in accordance with the disclosed subject matter;

FIG. 3 is a flowchart of the main steps in an exemplary embodiment of a method for enriched search, in accordance with the disclosed subject matter; and

FIG. 4 is an exemplary embodiment of an apparatus for providing enriched search, in accordance with the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is that in currently available solutions, the input to the search engine or another computing entity used for searching information is the query as entered by the user, and the results returned are all responsive to the query to some degree. However, no interconnection between the results is analyzed, detected or otherwise noted. For example, a user may look for an expert on a particular subject. The user may miss the fact that information about the school each expert attended can be obtained, which can also be valuable information the user may wish to further investigate.

Technical aspects of the solution can relate to an apparatus and method which retrieve data in response to a query, and look for common characteristics between the retrieved data items. Thus, new connections and relations between the returned search results are revealed and provide the user with new search or exploration dimensions, thus enriching the search results and options available to a user. The common characteristics can relate to attributes or to attribute values of the results. Thus, in the example above, the user looking for an expert on a particular subject can obtain a view detailing the schools attended by each expert, and can further drill down a hierarchy of this dimension, for example sort through country, city, school or the like.

Identifying common characteristics of query results is of importance whether all search results returned are of the same format or from the same data source, for example when searching in an organization database, if the results are returned from different data sources or in different formats, for example when using an internet search engine, or even when one or more of the data sources are internal for example within an organization, and one or more data sources are external.

In accordance with some embodiments of the disclosed subject matter, common characteristics are automatically identified between different results, wherein the common characteristics were not part of the original query, and become new dimensions of the result set. The new dimensions enable drill down and further search within the results, thus enriching the results.

The common characteristics can be identified using identical or similar attribute name, or identical or similar terms in different results. Similarity may be measured by complying with regular expressions, string matching, pattern matching, value containment or other textual similarity measurements.

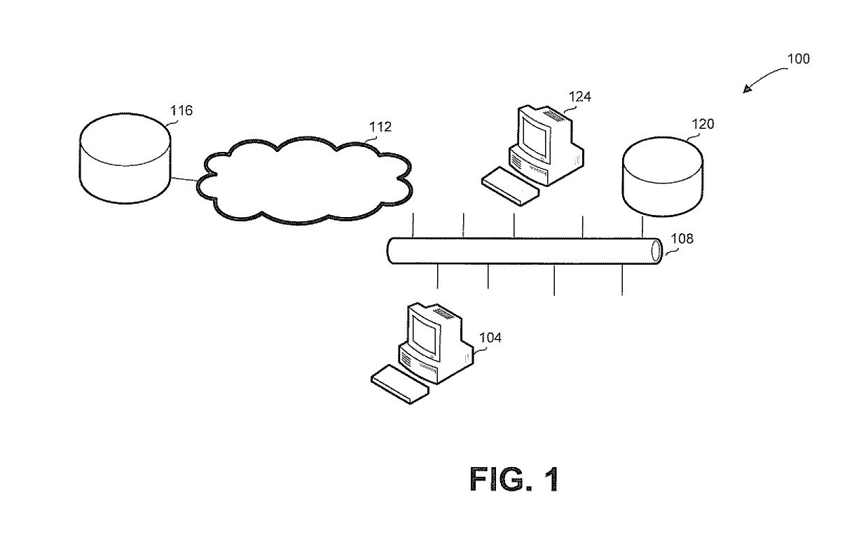

Referring now to FIG. 1, showing a schematic illustration of a typical environment in which the disclosed subject matter can be used.

The environment, referenced 100, provides search results for a user (not shown) using a computing platform 104, comprising a CPU and a memory device. Computing platform 104 can communicate with other entities that may provide data in response to queries, via a channel 108 such as a local area network (LAN), wide area network (WAN), intranet, Internet, or others.

The entities with which computing platform 104 can communicate to receive responses such as search results may include any further communication channel 112 such as the internet, which enables communication with storage 116, optionally via additional computing platforms such as computing platform 124. Storage 116 can comprise a data source from which the user wishes to retrieve information, such as an on-demand system for example a social network.

It will be appreciated by a person skilled in the art that storage 116 can be comprised of multiple storage devices and/or one or more servers for managing the storage.

The entities accessible to the user may also include entities on the same network, for example behind the same firewall. The entities may include storage device 120, optionally accessible through computing platform 124. Storage device 120 optionally stores an on-premise data source such as an HR database, an organizational chart, or the like, which contains information relevant for a group the user belongs to, such as an organization.

Some embodiments of the disclosed subject matter enable a user to issue a request such as a search request, and receive back results, from storage 116, storage device 120 or both.

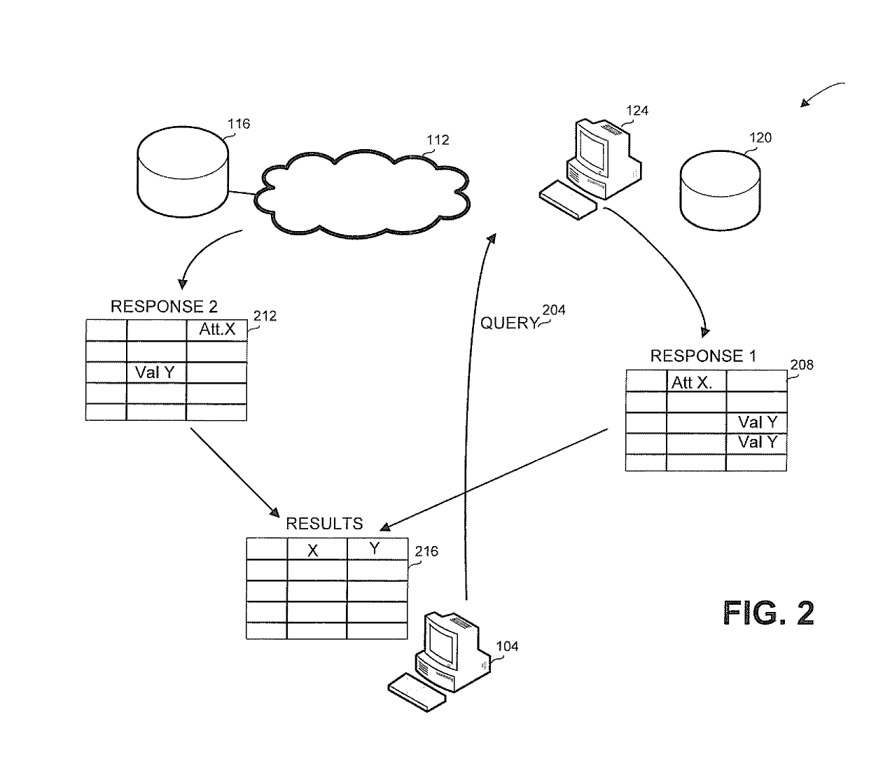

Referring now to FIG. 2, showing a schematic illustration of an exemplary apparatus for providing enriched search results.

The apparatus comprises computing platform 104 used by a user, as detailed in association with FIG. 1 above. The user may issue a request, such as query 204. Query 204 can be referred to an entity within the organization such as computing platform 124 or storage device 120, to an external entity, such as a search engine, available for example through internet 112, or both.

Computing platform 124 returns a first response, comprising a first result set 208, and an external computing platform returns a second response, comprising a second result set 212.

First result set 208 and second result set 212 comprise a common or similar attribute being attribute X, or contain common or similar value being value Y. it will be appreciated that first result set 208 and second result set 212 do not have to have the same values for attribute X, and also that value Y in first result set 208 and second result set 212 does not have to relate to the same attribute.

First result set 208 and second result set 212 are then returned in common result set 216, which is searchable in accordance with the terms of query 204, as well as in accordance with the common characteristics X and Y.

It will be appreciated that FIG. 2 is exemplary only, and that in some cases first result set 208 and second result set 212 can be both issued by one or more internal entities, or by one or more external entities. It will also be appreciated that the disclosed subject matter is not limited to processing two sets of responses, but is applicable to any number of responses. For example, a common result set can be compiled from an internal result set combined with results extracted for example from an organizational database, a social network or a professional network. In another scenario, multiple results contained in a single response can also be processed. For example, if a response from a search engine lists a number of results of different formats, the various findings can be analyzed so that a user can search in accordance with characteristic common to two or more of the results.

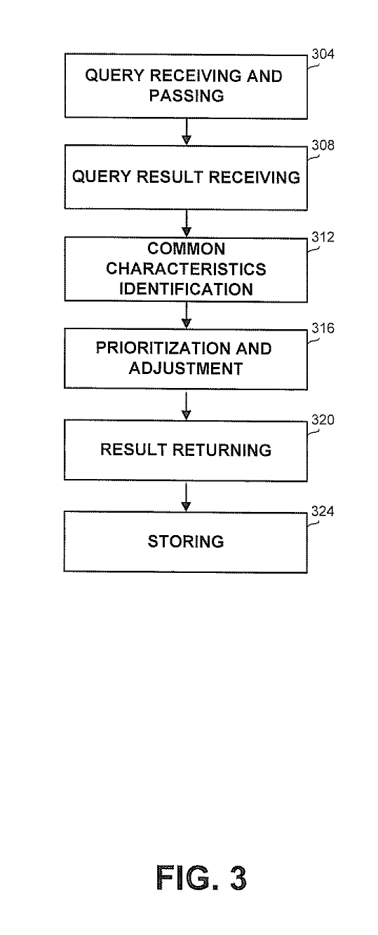

Referring now to FIG. 3, showing a flowchart of the main steps in a method for personalized search.

At query receiving and passing 304, a query is received for a user, and passed to a computing entity. The query may be received in any manner, such as textual, using a dedicate user interface, processing a batch, or the like.

The computing entity can be any computing platform, a computer, a service, a program, an application, a portal, a demon, a search engine, a web service, or the like, whether is processed within the same organizational network as the computing platform of the user, external such as a search engine searching through the internet or both.

At result receiving 308, results are received from one or more sources, whether internal to the user organization, external or both.

At common characteristic identification 312, characteristics common to any two or more of the results are identified. The characteristics may refer to a common or corresponding attribute, such as location, skill, role, education, hobby, or the like. For example if a user issued a query related to his co-workers, and for each worker there is an expertise indication, the user can then search through the returned records according to their expertise although it was not part of the initial query.

Alternatively, identification can relate to common values. For example, if records returned by a query which relate to co-workers, comprise a particular location such as a city, the user can search thorough the city and further drill down a location search dimension.

At prioritization and adjustment 316, the identified attributes or values are prioritized or personalized. Priorities can be determined, for example, by absolute or relative number of records sharing the common or similar characteristic or value. For example, if 98 out of 100 records share a certain characteristic, the results may be searched in accordance with the characteristic, but if 98 out of 10000 share it, then this search will not be enabled.

Another factor can relate to the absolute frequency of the characteristics within the language or the domain. For example, even if all or many returned records contain the number “0” in any field, it will probably not be added as a new search dimension. In some embodiments, there can be a tradeoff between the complexity or uniqueness of a characteristic and its frequency within the returned records. For example, a highly unique characteristic such as “Ph.D. degree” can be added as a search dimension even if only 50% of the returned records contain such information, while an “address” characteristic will be required to be indicated for 90% of the returned records.

Yet another factor can relate to user preferences, which can be introduced through a configuration file, by learning from how often in the past the user utilized the newly created search dimension, or the like. The prioritization can also take into account the context of the specific user, and give higher priority to common attributes which are also relevant for the user, such as the city he lives in.

It will be appreciated that multiple other factors can be designed and exercised for determining whether to add a characteristic as a search dimension.

At result returning 320, the result set is returned, wherein the result set is searchable according to the common characteristic. The result set is thus enriched and rather than comprising separate results without any relation therebetween, it is searchable in accordance with the newly identified characteristic. The searching can be enabled in a tabular manner, in a textual manner, using dedicated user interface or in any other form.

At storing 324, the common characteristics, the drill down options, user preferences or other data is stored within a persistent storage device for use in further sessions,

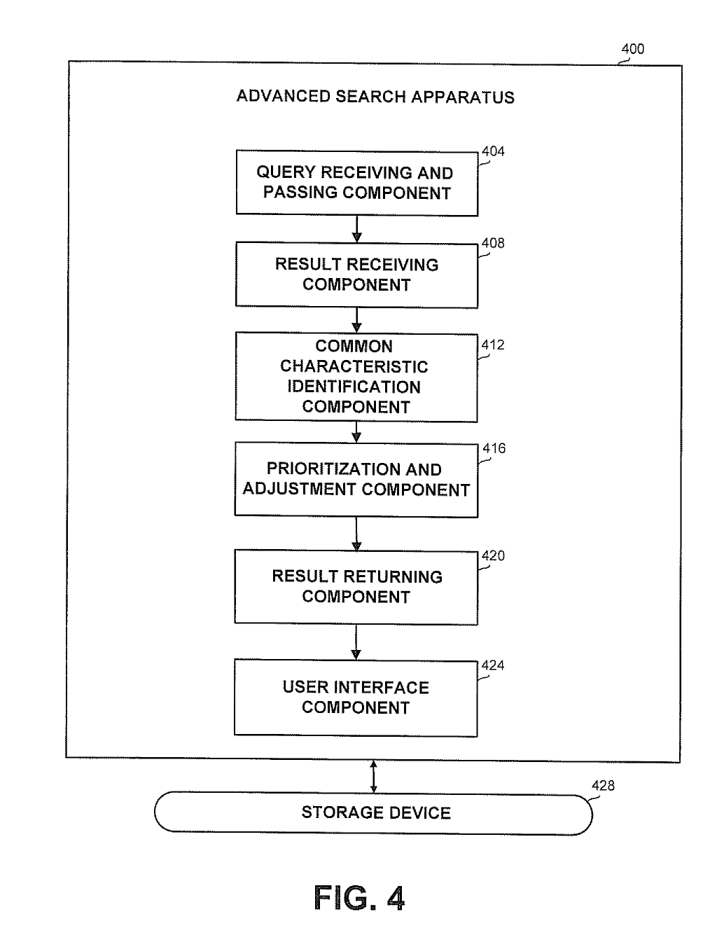

Referring now to FIG. 4, showing an exemplary embodiment of an apparatus for providing enriched search.

The enriched search apparatus referred 400 comprises one or more components, which may be implemented as inter-related sets of computer instructions. It will be appreciated that the division into components is conceptual and exemplary, and may depend in design choices.

Enriched search apparatus 400 comprises query receiving and passing component 404 for receiving a query as introduced by a user, and passing it to one or more entities for processing. The query may be received in text format, using a dedicated user interface, from a batch, over a communication channel, or the like.

Result receiving component 408 is responsible for receiving he results from the one or more entities that received the query. It will be appreciated that result receiving component 408 can be the same or in communication with the parts of query receiving and passing component 404 responsible for passing the query.

Common characteristic identification component 412 is responsible for identifying characteristics common to any two or more of the results returned. The characteristics may refer to a common attribute, such as location, skill, role, education, hobby, dimensions, color, or the like.

Alternatively, identification can relate to values. For example, if multiple records contain the same value, this value can be identified as a common characteristic.

Prioritization and adjustment component 416 is responsible for prioritizing or personalizing the common characteristics identified by common characteristic identification component 412. Priorities can be determined, for example, by absolute or relative number of records sharing the common or similar characteristic or value, absolute frequency of the characteristics within the language or the domain, user preferences, or others.

Result returning component 420 is responsible for returning the result set enriched with the new search dimension being the common denominator. The searching can be enabled in a tabular manner, in a textual manner, using dedicated user interface or in any other form.

User interface component 424 is a tool, a program, or the like that enables a user to search within the result set in accordance with the newly discovered common characteristic. If applicable, the user interface component can enable drill down, for example location can be drilled down as country-city-address, education can be drilled down with type of degree and then subject, or the like.

Optionally, the apparatus comprises persistent storage device 428 for storing the newly found characteristics, the drill down options, user preferences or other data that may be used in further sessions.

The disclosed method and apparatus provide for enriched and advanced search results, in which new dimensions are automatically revealed, and the user can explore and search through these dimensions, in addition to the original query as submitted, and obtain different views of the information. The exploration enabled to a user in response to the query is thus multidimensional and can in some cases be hierarchical or multi-level so that the user can drill down.

The new dimensions are provided in real-time, so that the user is automatically presented with the advanced exploration options.

The query may be intended to be responded by one or more internal data sources, one or more external data sources, or any combination.

It will be appreciated by a person skilled in the art that the disclosed method and apparatus are exemplary only and that multiple other implementations and variations of the method and apparatus can be designed without deviating from the disclosure. In particular, different division of functionality into components, and different order of steps may be exercised. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for providing search results by a processor at a computer, comprising:
receiving a query issued by the user and passing the query to at least one computing entity;
receiving at a first result and a second result from the at least one computing entity;
identifying at least one common characteristic of the first result and the second result; and
returning a result set comprising the first result and the second result, the result set being searchable in accordance with the at least one common characteristic.

2. The method of claim 1 further comprising prioritizing or adjusting the at least one common characteristic.

3. The method of claim 1 further comprising storing the at least one common characteristic on a persistent storage device.

4. The method of claim 1 wherein the at least one common characteristic is a corresponding attribute of the first result and the second result.

5. The method of claim 1 wherein the at least one common characteristic is a corresponding value of the first result and the second result.

6. The method of claim 1 wherein identifying the at least one common characteristic is done using at least one method selected from the group consisting of: regular expressions; string matching; pattern matching; value containment; and a textual similarity measurement.

7. The method of claim 1 wherein the at least one computing entity is a computer, a service, a program, an application, a portal, a demon, a search engine, or a web service.

8. An apparatus for providing search results, comprising:
a query receiving and passing component for receiving a query issued by a user, and passing the query to computing entity;
a result receiving component for receiving a first result and a second result from the computing entity;
a common characteristic identification component for identifying at least one common characteristic of the first result and the second result; and
a result returning component for returning a result set comprising the first result and the second result, the result set being searchable in accordance with the at least one common characteristic.

9. The apparatus of claim 8 further comprising a prioritizing or adjusting component for prioritizing or adjusting the at least one common characteristic.

10. The apparatus of claim 8 further comprising a storage device for storing the at least one common characteristic in a persistent manner.

11. The apparatus of claim 8 wherein the at least one common characteristic is a corresponding attribute of the first result and the second result.

12. The apparatus of claim 8 wherein the at least one common characteristic is a corresponding value of the first result and the second result.

13. The apparatus of claim 8 wherein identifying at least one common characteristic is done using at least one method selected from the group consisting of: regular expressions; string matching; pattern matching; value containment; and a textual similarity measurement.

14. The apparatus of claim 8 wherein the computing entity is a computer, a service, a program, an application, a portal, a demon, a search engine, or a web service.

15. The apparatus of claim 8 further comprising a user interface component for letting a user search within the result set in accordance with the at least one common characteristic.

16. A computer readable storage medium containing a set of instructions for a general purpose computer, the set of instructions comprising:
receiving a query issued by a user and passing the query to at least one computing entity;
receiving at a first result and a second result from the at least one computing entity;
identifying at least one common characteristic of the first result and the second result; and
returning a result set comprising the first result and the second result, the result set being searchable in accordance with the at least one common characteristic.

17. The computer readable storage medium of claim 16 wherein the set of instructions further comprises prioritizing or adjusting the at least one common characteristic.

18. The computer readable storage medium of claim 16 wherein the set of instructions further comprises storing the at least one common characteristic on a persistent storage device.

19. The computer readable storage medium of claim 16 wherein the at least one common characteristic is a corresponding attribute of the first result and the second result.

20. The computer readable storage medium of claim 16 wherein identifying at least one common characteristic is done using at least one method selected from the group consisting of: regular expressions; string matching; pattern matching; value containment; and a textual similarity measurement.
